(19) United States
(12) Patent Application Publication
(10) Pub. No.: US 2005/0182745 A1
(43) Pub. Date: Aug. 18, 2005

(54) Method and apparatus for sharing information over a network

(76) Inventors: Jasjit S. Dhillon, Rancho Palos Verdes, CA (US); Mark Damian Jeffrey, Santa Monica, CA (US); Todd Kamin, Atlanta, GA (US); Frederick Sidney Conklin, Orinda, CA (US); Peter Stewart Hutto, South Pasadena, CA (US); Stanley Bruce Crair, San Marino, CA (US)

Correspondence Address: KENYON & KENYON, 1500 K STREET NW, SUITE 700, WASHINGTON, DC, 20005, US

(21) Appl. No.: 10/902,078

(22) Filed: Jul. 30, 2004

Related U.S. Application Data
(60) Provisional application No. 60/491,561, filed on Aug. 1, 2003.

(51) Int. Cl. G06F 7/00

(52) U.S. Cl. 707/1

(57) ABSTRACT

Embodiments of the present invention include an information sharing system that provides an online business service from a provider that uses the Internet to enable individuals and organizations to link together contact databases that reside in multiple desktop applications and create a unified meta-database. This database can be searched by individual subscribers in order to locate a specific entity (such as an organization or a person, by name, title or organization, such as an executive in a target organization), identify if a path to the executive exists through a chain of contacts across the linked contact databases, and request a referral based introduction to the specific executive.

### RELATED APPLICATIONS

The present application claims priority to U.S. Provisional Patent Application No. 60/491,561 filed on Aug. 1, 2003, the disclosure of which is incorporated herein in its entirety.

### BACKGROUND OF THE INVENTION

The present invention pertains to a method and apparatus for sharing information over a network such as the Internet. More particularly, the present invention pertains to the creation and use of a person-to-person network of individuals. For example, through such a network, a first subscriber may obtain an introduction to or referral to a “contact” (e.g., a person, corporation, etc.) which is maintained in the database of a second subscriber.

A personal network is a valuable and underutilized asset. Building personal connections in business, professional and social life is a lifelong process. The foundation of this network is based on trusted relationships. Current methods of expanding and keeping an individual trust network are slow, time consuming and require great personal effort. As is well-known, the most successful people have personal trust networks with exceptional depth and strength that integrate lifetime business and personal relationships into a seamless whole. Business and personal success depends greatly upon the ability to enhance the depth, strength and span of trust networks.

In today's world of information overload it is difficult to rise above the noise of the competition, identify the right economic decision makers and have the opportunity to meet with them in timely manner. Traditional sales and marketing methods and processes are costly and do not provide any guarantee that a message has reached the right person. Personal trust networks are a much more effective method of getting to the right person in time, with relevance. A methodology and technology for rapidly enhancing the depth, strength, and span of a trust network is needed to solve this obvious predicament.

An existing personal trust network has tremendous untapped potential. Accordingly, there is a need to improve the effectiveness of a personal trust network.

### SUMMARY OF THE INVENTION

Embodiments of the present invention include an information sharing system that provides an online business service from a provider that uses the Internet to enable individuals and organizations to link together contact databases that reside in multiple desktop applications and create a unified meta-database. This database can be searched by individual subscribers in order to locate a specific entity (such as an organization or a person, by name, title or organization, such as an executive in a target organization), identify if a path to the executive exists through a chain of contacts across the linked contact databases, and request a referral based introduction to the specific executive.

### BRIEF DESCRIPTION OF THE DRAWINGS

FIG. 1 is a block diagram of a system for creating a person-to-person network according to an embodiment of the present invention.

FIGS. 2a-b are flow diagrams for implementing a method of extracting contact candidates according to an embodiment of the present invention.

FIG. 3 is an example of a display showing contact candidates and corresponding weight values.

FIGS. 4a-b are flow diagrams for implementing a method of generating a networked contact management system according to an embodiment of the present invention.

FIG. 5 is a flow diagram for implementing a method of synchronizing contacts in the network system with those of a user's computer system according to an embodiment of the present invention.

FIGS. 6a-c are flow diagrams of a method for creating and searching an index for contacts in the network system according to an embodiment of the present invention.

FIG. 7 is a screen display showing an example of the results of the method of FIGS. 6a-c.

FIGS. 8a-d are flow diagrams of a method for creating/removing a high trust level relationship and for displaying contacts of a high trust level member according to an embodiment of the present invention.

FIGS. 9-12 are screen displays showing an example of the results of the method of FIGS. 8a-d.

FIGS. 13-15 are examples of electronic mail messages generated during embodiments of the present invention.

### DETAILED DESCRIPTION

The present invention is based on the concept of selective sharing of trust networks. A subscriber to the present system has the ability to expand a network immediately by sharing it with the subscriber's closest associates, friends and confidants. In turn, they are encouraged to share their trust networks with the subscriber. This process can enable the subscriber to almost exponentially increase the depth, strength and span of a trust network over a relatively short time frame.

According to an embodiment of the present invention, a person-to-person network is created that allows a first subscriber to obtain a referral from or introduction to “contacts” of a second subscriber. This network is a secure, online solution that makes the selective sharing of trust networks a reality.

To become a subscriber to the system according to an embodiment of the present invention, there are two options. The first option is to be invited by an already-existing subscriber. That option allows the potential subscriber to have access (as a subscriber) to the trust network established by the already-existing subscriber. The second option is for a potential subscriber to contact the service provider (such as by going to the provider's web site) and creating a trust network, to which the potential subscriber invites close associates and confidants to also become subscribers. In furtherance of this second option, once the potential subscriber has been approved by the service provider, the potential subscriber is provided with an unique, secure ID that is used to access the service. At this point, the potential subscriber decides which contacts and which information from the potential subscriber's personal computer contact database will be included in the secure online network. Once the potential subscriber has been provided with the secure IUD (thus becoming a subscriber) and has created an online trust network, other members of this trust network who are identified in the subscriber's contact database can be invited to join the system as subscribers and share their respective contact databases with the first named subscriber. The network provider supplies the technology to conduct searches across expanded trust networks while maintaining complete confidentiality of the names and contact information of the search target. The trust network members (subscribers) can also conduct searches across the network of people listed in the database and the system provides for an automated maintenance of changes of contact information within the trust network.

Examples of the features of the present invention can be broadly understood as follows:

First, streamlining and accelerating the process of analyzing the contacts stored in desktop applications, determining the important contacts based on proprietary algorithms, presenting these contacts (typically in a hierarchy) to the individual subscriber for review and enabling the subscriber to upload the selected contacts to a custom networked contact manager, which may be operated by the provider, that is auto-generated on the fly to store the subscribers contacts.

Second, a subscriber can then invite contacts from the subscriber's contact database to join the system and link their contact networks to the contact network of the subscriber. As more and more individuals join the network and become subscribers, the search space of paths to people through trusted referrals grows dramatically.

Features of embodiments of the present invention include the following:

(a) Automated Analysis of E-mails to extract Important Contacts: The subscriber software (such as that used with Microsoft® Outlook) automatically analyzes the “Sent Messages” folder in the subscribers' E-mail systems on desk-top applications and determines the most important contacts in a contact database. An algorithm uses frequency and recentness of communications divided by a time-series to determine the most important contacts over a specified time-frame. The software then prepares and presents this list of contacts to the subscriber for upload (such as to the database maintained by the provider) and to be invited to join the information sharing network. This process reduces the time taken to analyze large data-sets of tens of thousands of contacts to a matter of minutes.

(b) Auto-generation of a Networked Contact Management System through a bulk-upload of contacts from a desktop application. Once the subscriber has uploaded contacts to the system, the system or the provider automatically generates a web based contact management system that is accessible through any web device.

(c) Auto Synchronization of Contacts from a Networked Contact Manager to a Desktop Application: Once a contact database has been created, a subscriber can invite any one of the contacts to join the system. When one of the contacts does accept the invitation and joins the system, the system, preferably under control of the provider, automatically synchronizes the contacts' latest contact information with the existing record in the subscriber's desk-top contact manager. This can be done automatically or on pre-defined intervals. This dramatically reduces the time a user needs to keep his desk-top contact database current and synchronized with the overall contact database.

(d) Searches: The information sharing system includes a number of search processes and search result presentation styles. A subscriber can search for a target executive or organization from within Microsoft® Outlook by entering the search criteria in the information sharing system search box. Searches can also be conducted in the information sharing system's web application. In summary, the search process allows for a search to be initiated from a desktop application through a series of networked (Internet) based contact databases and presents the results back to the subscriber inside the desktop applications. Search results are presented in a number of different formats. Subscribers can then request introductions to their targets directly from within the search result window. Searches are as follows:

A typical search for a target may yield the following results:

General Search: First subscriber John Doe Confidential (Target). The subscriber can then request John Doe to provide an introduction to the target.

Inner Circle Search: First Subscriber John Doe to James Smith, Manager, Target Company. The first subscriber can then request an introduction to Mr. Smith from Mr. Doe. If the First Subscriber and Mr. Doe are members of each other's Inner Circle, there is an explicit advance agreement to allow each other access to the detailed contact information of the contacts in the system contact database.

Confidential Squared Search: First Subscriber->Confidential->Confidential (Target Company). This search indicates that there is someone in the subscriber's own network who can make an introduction to the Target Company, but they want to keep their name private. The First Subscriber can still send the person under the Confidential label an introduction request and get a reply.

Concept of Inner Circle i.e. Reciprocity: The present system has also pioneered the concept of the “Inner Circle” when it connects contact databases of subscribers over the Internet. The inner circle concept allows subscribers to take their relationship to a higher level of trust by enabling them to selectively invite other subscribers to not only search across their contact database but also browse in real time and view detailed contact information on the contacts in their individual databases.

Concept of Groups: The present system also pioneered the concept of search and browse groups in the networked contact database world. In other words, a subscriber may set up a group of contacts that is a sub-set of the subscriber's entire contact database. The subscriber can then provide selective access to the subscriber's contact database by limiting the access of other subscribers to specific groups. This is especially useful in the case where a Senior Executive may want to open up parts of a network database selectively e.g. groups by Account, by project etc.

1. Concept of Gatekeepers: The system may include a search and communication filtering processes embodied in its service. For example, an individual may limit access to his network by setting any number of personal preferences. These include a gatekeeper function where a subscriber designates a second subscriber to screen all search requests that require access to the first subscriber's network.

As another example, a subscriber may impose access filters such as an election to receive search requests only from specific individuals, on predesignated topics and on a pre-specified frequency per month.

A third feature of the present system is referred to as subscriber agent/affinity matching. One of the biggest challenges in social networks is to match individuals based on fuzzy profiles and interests. The present system pioneers the use of Semantic Agents that perform the following tasks:

Profiling and Intelligent Matching of People: The present invention will create profiles of members based on their personal and business information and the connections they are making in the system. The system will then use these rich profiles to create recommendations for introductions between subscribers or contacts who may be working on similar projects, facing similar personal challenges, experiencing similar life transitions, etc. The system will connect members with people they should know based on shared values, vision, goals, etc., and will make the auto-matching of individuals across wide-area networks a reality.

Business Intelligence and Targeted Introductions: Subscribers will have the ability to instruct the system to observe specific industries and companies by mining public and private sources of information. The system would then report back with recommendations on Executives that a subscriber needs to know in a target company based on unique and personalized criteria e.g., a subscriber could make inquiry through the system to ferret out and report back all the senior executives involved in WiFi strategy and investment at a target company. The subscriber could also query the system to find me a path to these Executives through the information sharing system network.

Inferred Networks: The system includes the ability to mine public and private data sources and automatically infer network paths and connections between Executives, Investors, Board Members, Regulatory Officials and Academia. This will enable the system to proactively create high-value specialized network segments to include in its larger network service offering.

The present invention will be described with reference to a network system. In one embodiment, the network system is the Internet, but the present invention can be extended to other types of network systems including local area networks (LANs), wide area networks (WANs), Intranets, etc.

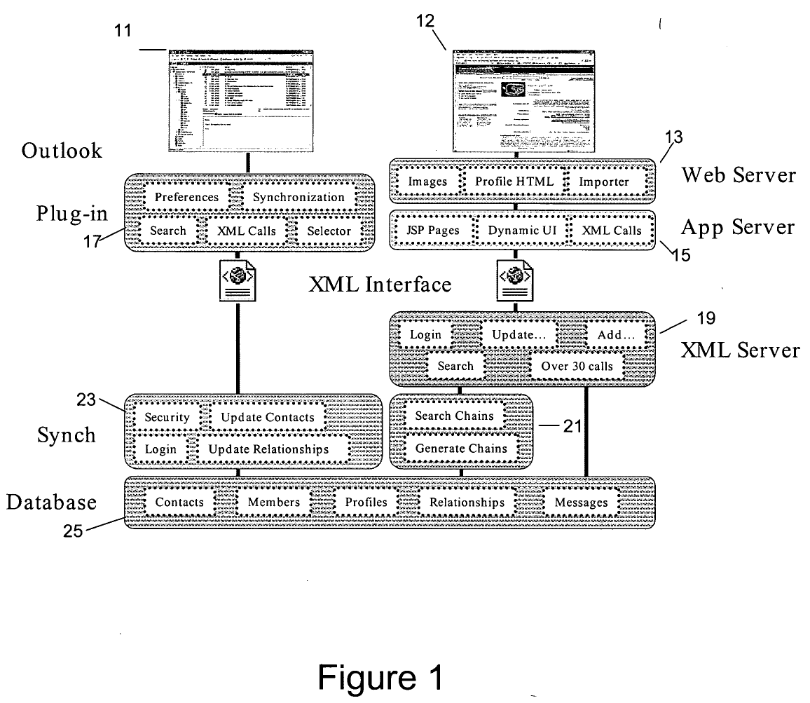

Referring to FIG. 1, a block diagram of a network including a system of the present invention is shown. In the network system, a plurality of user computer systems may be provided such as user computer 11 and 12. In this figure, the user computers 11 and 12 are general purpose personal computers including one or more processors to execute instruction code stored in a storage media such as a hard-disk drive, Compact Disc-Read Only Memory (CD-ROM), or the like. One skilled in the art will appreciate that the present invention can be expanded to a variety of other computer systems (e.g., those operating over a local network) or electronic communication systems (e.g. two-way pagers, hand-held devices, etc.). In this embodiment, each user computer 11 is capable of running a program such as the Microsoft® Outlook program (sometimes referred to as a personal information manager or “PIM” as well as a personal CRM or PCRM).

Referring to FIG. 1, the user computer 11 includes a plug-in component 17 allowing it to effectively interface with a network system such as the Internet. This is shown in FIG. 1 as an XML interface. A server system is also provided coupled to the network. In this example, the server system includes a synchronization component 23 to provide login and security operations. The synch component also can be used to update contact and relationships as described below. A database 25 is provided that stores various information concerning the users and their contacts and relationships. A search component 21 is provided that may be used to search the information stored in database 25. An XML server component 19 may also be provided to provide an XML interface between a network and the server system.

In this example, user computer 12 is coupled to the network via a web server 13 and an application server 15. As can be seen from FIG. 1, user computer 11 communicates with the server system through its Personal Information Manager (e.g., Outlook) that has been modified by the plug-in component 17 to allow the user to search and retrieve information directly in the PIM-without having to open up other applications. User computer 12 provides an alternative manner for accessing the server system (i.e., through any of a variety of known web browsers).

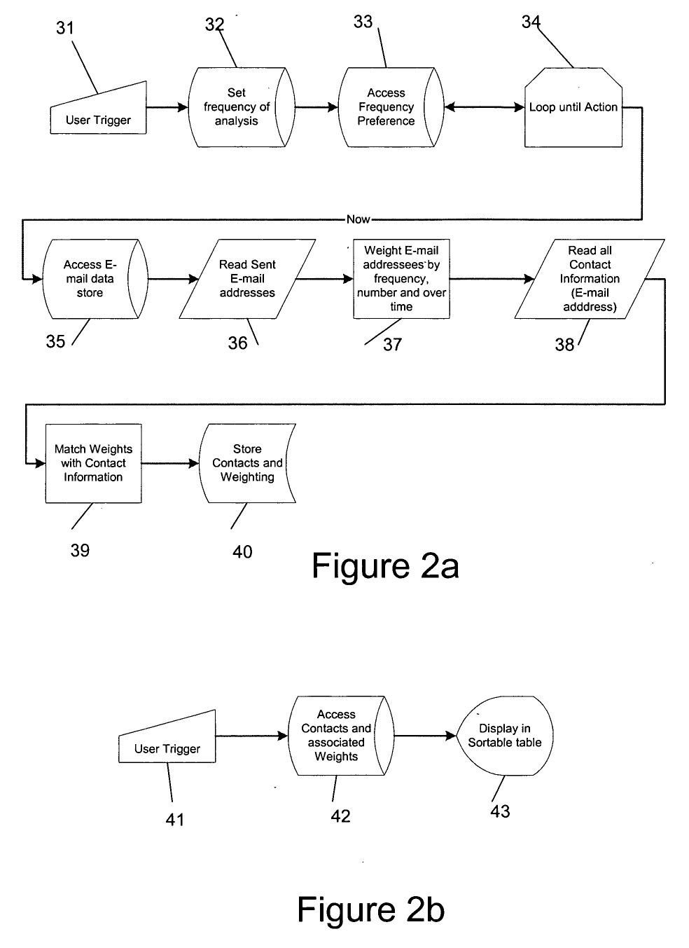

According to an embodiment of the present invention, automated analysis of E-mails is performed to order them in relative importance to the user and extract contact information. Example flow diagrams for implementing such a method are shown in FIGS. 2a-b. Prior to the method shown in these figures, a first user has performed any necessary preliminary actions to log into the server system of FIG. 1 and create an account. The method of FIG. 2a begins in block 31 with a user trigger. In this example, the user has been prompted with a query requesting whether an automated analysis of the users' E-mail is to be performed. In block 32, the frequency of analysis is set. In this example, the frequency value can be set by the user to filter which potential contacts in a particular E-mail to include in the user's list of contacts for the person-to-person network. Alternatively, a frequency value may be predetermined by a third party. In block 33, frequency preferences for the server system are accessed and presented to the user.

Once the user authorizes a search of contacts from E-mail (block 34), control passes to block 35 where execution of the program accesses a plurality of E-mail messages at the user's computer. For example, the E-mail messages in the “Sent Messages” folder for the Microsoft® Outlook program may be accessed. In block 36, the E-mail addresses in the “To:” field are read. Other information may be collected as well, in particular timing information (i.e., when the E-mail message was sent). The collected data from the folder are then analyzed locally at the user computer, transmitted back to the server system for analysis, etc. In block 37, the collected addresses are weighted based on relevance. In this embodiment, the weighting is performed based on frequency of occurrences and total number of occurrences. More weight may be placed on contacts appearing more recently. In block 38, the contact information for each E-mail address is read. For example, the address in the “To:” field is matched to the additional information provided for that address in the “Contacts” folder of the Microsoft® Outlook program. This information may include, the contact's name, telephone and fax numbers, address, etc. In blocks 39 and 40, the weight values are matched to the contact information, and stored.

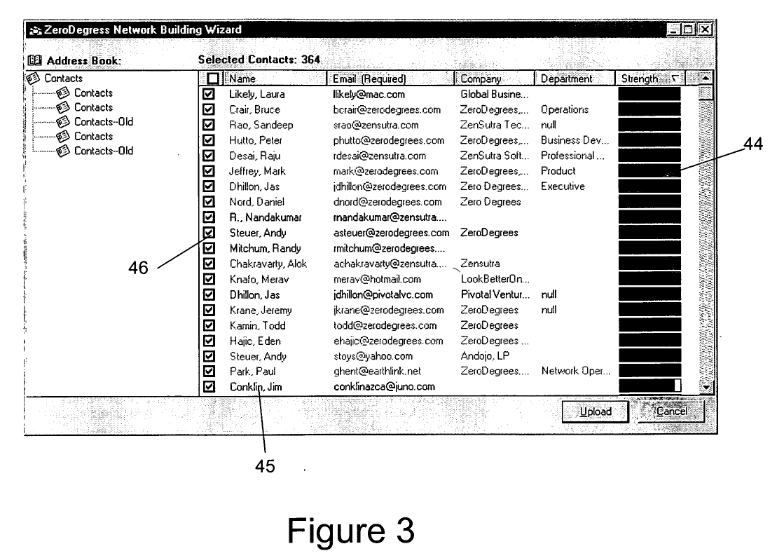

In the example of FIG. 2b, at least a portion of the contact information and the corresponding weight values are displayed to the user. For example, a user input (block 41) causes the program to access the contact/weight information (block 42) and display it to the user (block 43). An example of such a display is shown in FIG. 3. In FIG. 3, the potential contacts 45 are shown with the corresponding weight values 44. The user may be provided with a check box 46 to select which contacts to include for his/her personal network of contacts. Using the method and system described above, a subscriber is able to identify and collect a group of contacts for use in the person-to-person network. Much of this can be done automatically, distilling what may be tens of thousands of contacts quickly and efficiently.

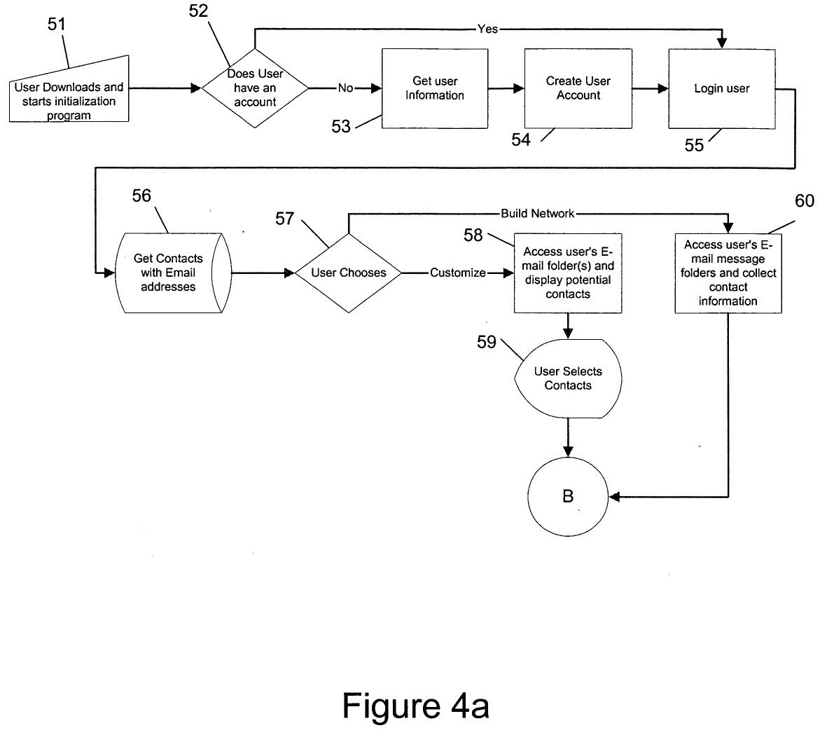

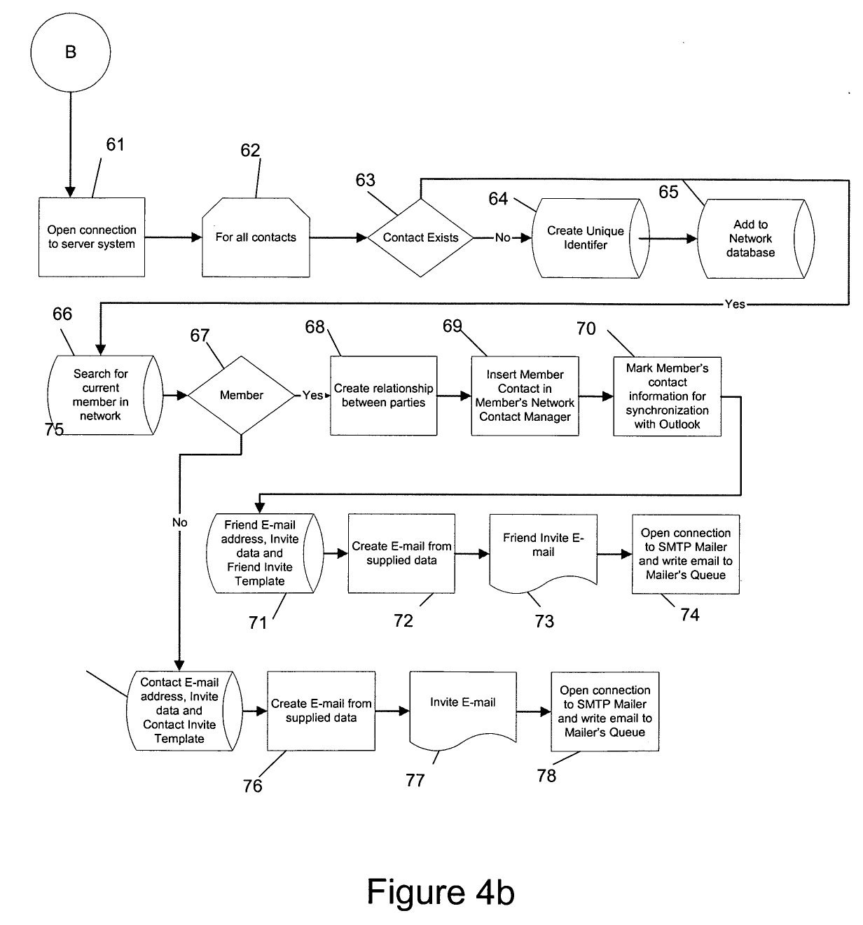

According to an embodiment of the present invention, a web-based contact management system may be automatically generated for subsequent access by a user. Referring to FIGS. 4a-b, a flow diagram of a method according to an embodiment of the present invention is shown. In FIG. 4a, in block 51 the user downloads and starts at his/her computer system an initialization program from the server system. In decision block 52 it is determined whether the user has an existing account with the server system. If it does not, then control passes to block 53 to obtain user information and create an account (blocks 53 and 54). In block 55, the user logs in to the server system. Control then passes to block 56.

In block 56 a list of contacts for the user is generated (e.g., through the method described in FIGS. 2a-b). In decision block 57, the user is given the option to build a network or customize a network. If the user desires to customize the network then control passes to block 58 where the user's E-mail messages are accessed and potential contacts are displayed to the user. In block 59, the user then selects which of the contacts will be used in the network system (see, FIG. 3). Control then passes to the flow diagram of FIG. 4b. Alternatively, the user may desire that the server system automatically generate the list of contacts to be used in the network system. In such a case, control passes to block 60 where the user's E-mail messages are accessed and a list of contacts collected (e.g., based on predetermined criteria). Referring to FIG. 4b, as indicated in block 61, there is already an open connection between the user's computer and the server system. In block 62, the program loops through all contacts. If a contact exists in the network database (decision block 63), then control passes to block 66 and the program searches current members of the network to see if the contact is also a member of the system. If there is a match (decision block 67), then control passes to block 68 to create a relationship between the parties (i.e., store in the database system that there is a relationship between the parties. In block 69, the “member contact” (i.e., the contact information for the contact already in the network) is inserted into the contact manager for the new user/member. In block 70, the contact information for the “member contact” is marked for synchronization with the contact organization program (e.g. the Microsoft® Outlook program) as described in further detail below. In block 71, the E-mail address for the member contact is retrieved along with “invite data” (e.g., including information about the person making the invitation), and a “friend invite” template. In blocks 72-73, a friend invite E-mail message is generated and sent out (see block 74). In this example, a friend relationship is one where both parties are members of the network, and they have a direct relationship with one another that has been approved by both parties.

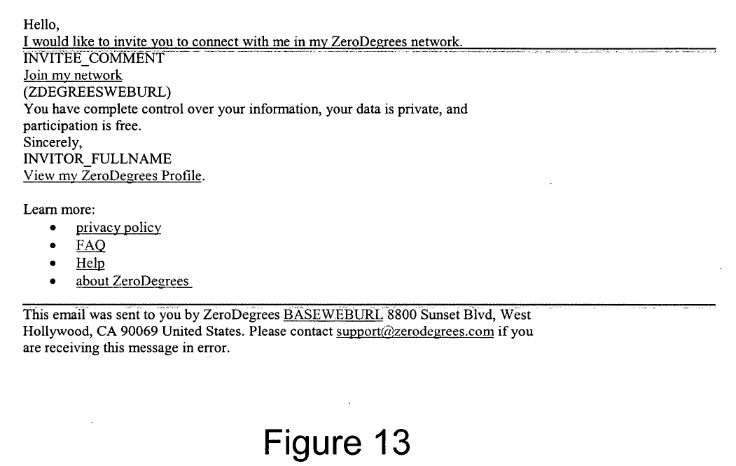

If the contact is not a member (decision block 67), then control passes to block 75, where the E-mail address for the contact is retrieved along with invite data and a “contact invite” template. In blocks 76-77, an E-mail message is generated for the contact and sent out (see block 78, and an example of this E-mail message is shown in FIG. 13). In this example, the purpose of this E-mail message is to alert the identified contact of the network system and the involvement of the user. Such an E-mail could provide instructions that would allow the contact to also become a member of the network system. In this case the inviting member's tracking code is used to bind to the contact invitation so that on accepting the invitation, it will mark the person as being invited by the member.

Referring back to decision block 63, if the contact does not exist in the network database, then control passes to block 64 where a contact entry is created for the network database. The entry would include the contact's information (e.g., E-mail address, office address, phone number, etc.) and also a unique identifier in the system. In block 65, the contact is added to the network database. In both cases a person's contact information is added and related to the member as each member can have a different view of a contact. (e.g., individual users may have different contact information for a different person/entity). In this case, the system will save this person/entity two separate contacts in the individual users' network.) As seen from the above, once the user has identified a collection of contacts, the system is able to automatically generate a networked contact management system. In this embodiment, the system is able to:
1. update the network database of the server system with new contact information;
2. identify those contacts who are already members of the network and alert them to the introduction of the user to the network; and
3. initiate a dialog with the other contacts to increase the number of members in the network.

At the completion of the method of FIGS. 4a-b, the user may be provided with a web-based contact management system that is accessible through any web device.

According to an embodiment of the present invention, once a contact database has been created for a user, a subscriber may invite any one of the contacts to join the system. When one of the contacts does accept the invitation and joins the system, the system, preferably under control of the provider, automatically synchronizes the contacts' latest contact information with the existing record in the user's contact manager at his/her computer. This can be done automatically or on pre-defined intervals.

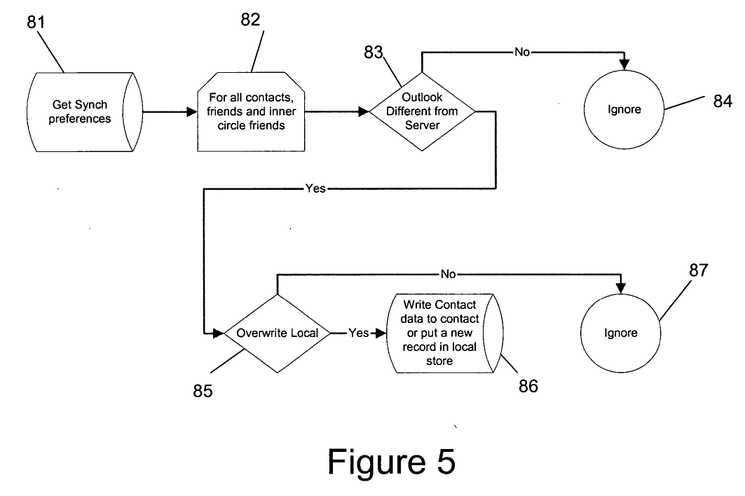

Referring to FIG. 5, a flow diagram for implementing a method according an embodiment of the invention is shown. In block 81, the synchronization preferences of the user are retrieved. For example, the user may indicate that synchronization is to take place each time he/she logs into the network system of the server. Other options are available (e.g., once every week, etc.). In block 82, the program loops through each contact, friend, and inner circle friend of the user. As used herein, “inner circle friends” refers to two “friends” (as described above) who have both agreed to share contact information with each other. In decision block 83 if the user's database differs from the database on the server control passes to decision block 85 (if not, the contact is ignored as in block 84).

In decision block 85 it is determined whether user synchronization preferences allow for automatic overwrite of the user's local database of contact. If it does allow automatic overwrite, then in block 86, the contact data in the user's local database is updated. If it does not, then control passes to block 87 and the discrepancy is ignored. Such information may be forwarded to the user so that he/she may make explicit decisions as to whether to update his/her database. Using this method may dramatically reduce the time a user needs to keep his/her local contact database current and synchronized with the overall contact database of the network (as kept by the server system).

Once a user has created his/her contact database, the resulting network database of contacts may be searched in a variety of ways. For example, the system of the present invention may include a number of search processes and search result presentation styles. A subscriber to the network system may search for a target executive or organization from within Microsoft® Outlook by entering the search criteria in the information sharing system search box. Searches may also be conducted in the information sharing system's web application. In summary, the search process allows for a search to be initiated from a desktop application through a series of networked (e.g., Internet) based contact databases and presents the results back to the subscriber inside the desktop applications. Search results are presented in a number of different formats. Subscribers can then request introductions to their targets directly from within the search result window.

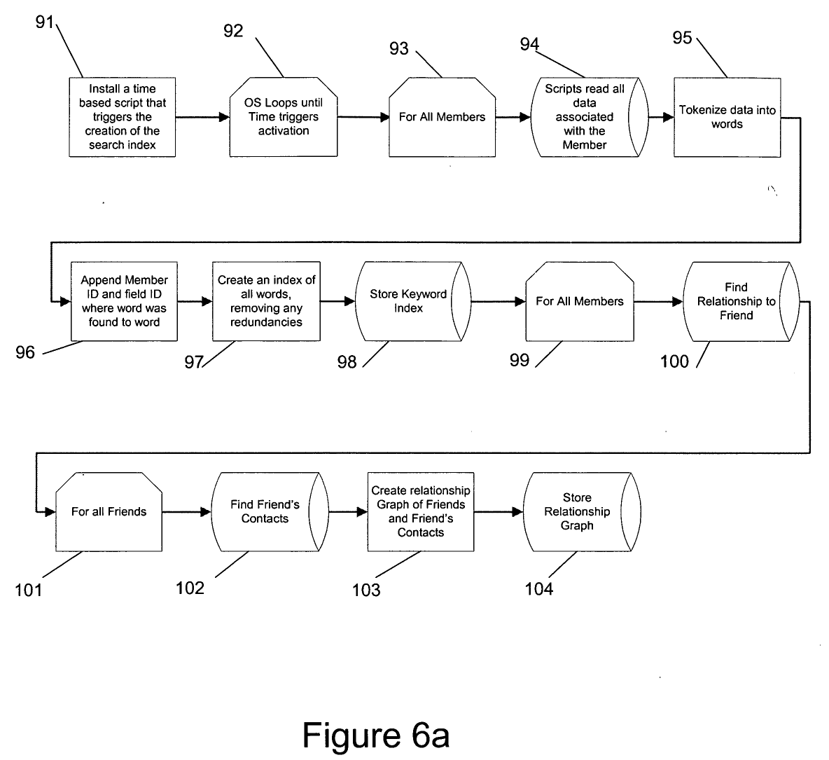

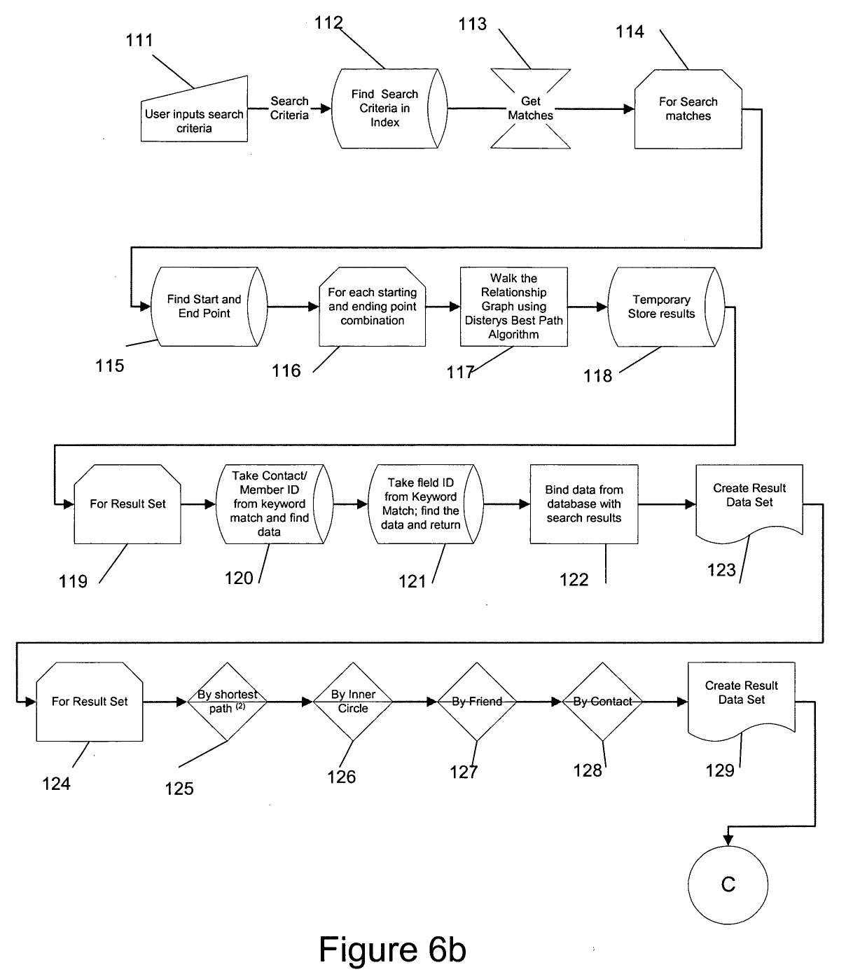

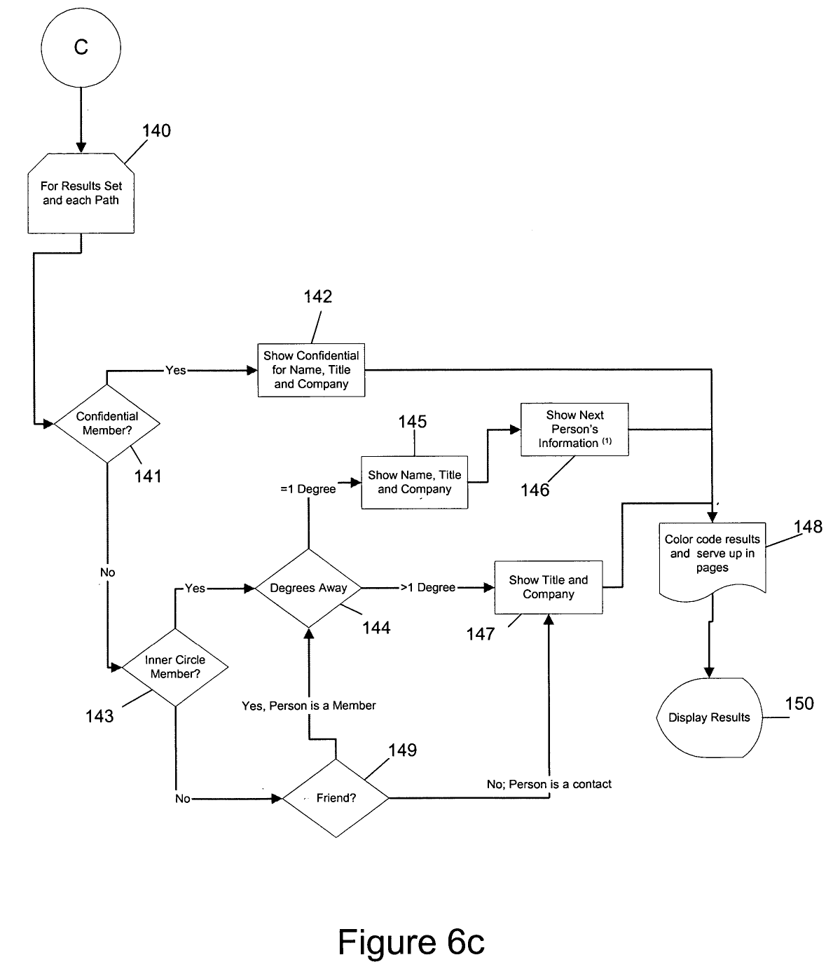

Referring to FIG. 6a, a flow diagram for creating a searchable index and relationship graph is shown according to an embodiment of the present invention. In block 91, a time-based script that triggers the creation of the search index is installed. In other words, it is often undesirable to recreate a search index continuously because doing so takes us processing bandwidth. Accordingly, the time-based script may be used to indicate when a search index should be create (re-created). In block 92, the operating system (OS) loops (i.e., waits) until time triggers activation. Control then passes to block 93, and the program loops through all members of the network. In this example, the network is the universal network kept by the server system. In block 94, the program scripts cause all data associated with the member to be read. Such data could include contact information, business information, personal interests, etc. In block 95, the data read concerning the member is tokenized into words using any of a variety of known methods. Each entry in the index may be associated with a member and may be associated with a field in the data associated with a member. In block 96, the member ID and field ID, where the keyword is found, is appended to the keyword for facilitating the search. In block 97, an index of all keywords is created removing any redundancies. In block 98, the keyword index is then stored for later searching.

In block 99, the program loops for all members to find “friends” (as described above) in block 100. Then, in block 101 and 102, the program loops through each friend to collect the contacts associated with that friend. In block 103, the relationships between friends and contacts is formed in a relationship graph. In other words, the relationship graph represents the user's relationship to its friends and contacts as well as the contacts of the user's friends. In block 104, the relationship graph is stored.

Referring to FIG. 6b, a flow diagram for performing a general search is shown. In block 111, a user input search criteria for the system. Such search criteria can be a selection of keywords, data fields, etc. In block 112, the search criteria is compared to the index (e.g., generated in block 98 of FIG. 6a). In block 113, the matches with the contacts are collected. In blocks 114 and 115, for each search match, the program loops through finding the start and end points between the user and the matched contact. In blocks 116 and 117, for each starting and ending point combination for the user and matched contact, the program analyzes the relationship graph to map a relationship between the two (e.g., using Dijkstra's Best Path Algorithm which is known in the art for searching network connections). These results are then stored (block 118).

In block 119, the program loops through the results set and for each match, retrieves the contact/member ID (block 120) and the data associated with the contact/member ID is retrieved (block 121). In block 122, the data from the database on the matched contact/member is binded with the search results. A result data set is created (block 123). Then for each result set, the program looks through the matches to rank the results (block 124). In this embodiment, the results are ranked first by shortest path. In other words, if the matching contact is a “friend” of the user, then such a path would be shorter compared to a matching contact that was only a contact of a “friend” of the user. The results can also be ranked by a trust level of the matching contact. In this embodiment, “inner circle” contacts (block 126) are ranked higher than “friend” contacts (block 127) and general contacts (block 128). In block 129, the result data set is created.

Referring to FIG. 6c, the program loops through the result set (block 140) and determines whether the contact is a “confidential” member. In this embodiment, any member may designate themselves as “private” or “confidential,” which prevents their contact information from being displayed as part of the search results. For example, if the contact match is a contact of a user's “friend,” there is a strong likelihood that the user and the matching contact do not personally know each other. Accordingly, the “confidential” designation prevents a member's contact information from being unduly distributed to others without his/her control. If the matching contact is a confidential member, then control passes to block 142 and identification information for the matching contact is not shown (or is replaced by the designation “Confidential”). Then the results are color coded and displayed in pages to the user (see block 148 and 150).

According to one embodiment of the present invention, if the matching contact is not a confidential member (decision block 141), then control passes to block 143 to determine if the relationship path between the matching contact and the user includes an “inner circle” contact. If so, then control passes to decision block 144 to determine the number of degrees between the user and the matched contact (i.e., how many people are between the user and the matched contact in the relationship graph). If there is one degree of separation, then control passes to block 145, and the name, title, and company of the inner circle friend can be displayed as will as the matching contact's information (block 146), and control passes to blocks 148 and 150. If the matching contact is more than 1 degree separated from the user, then only the title and company of the matching contact (block 147) can be displayed.

If there are no inner circle members between the user and the matching contact, then control passes to decision block 149 to determine whether there is a “friend” between the user and the matching contact. If there is, then control passes to decision block 144 to determine the number of degrees between the user and the matching contact, as with the “inner circle” example, in this embodiment, if there is only the “friend” between the matching contact and the user, the contact information for the friend and the contact is shown. If there is no friend in the relationship path between the user and the matching contact, then the matching contact is simply a contact and only the title and company of the matching contact is shown (block 147) in this embodiment.

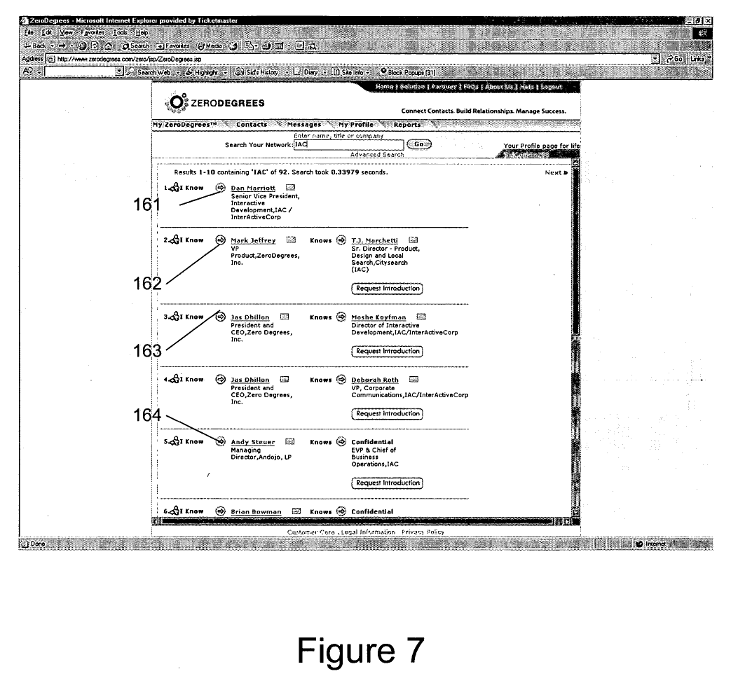

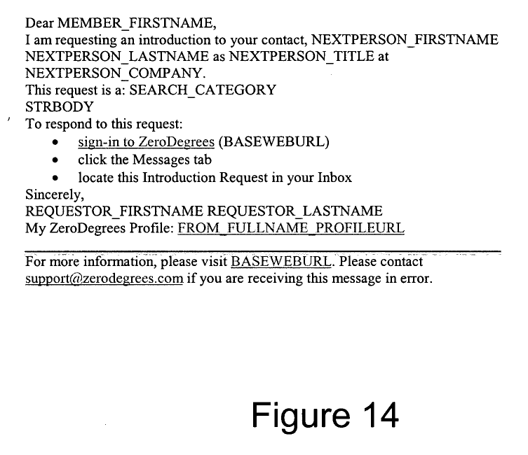

Referring to FIG. 7, an example of a screen display for the search results of FIGS. 6a-c is shown. In FIG. 7, the arrows, e.g., arrows 161-165 may be color coded to indicate the type of relationship between the user and the identified contact. For example, one color would identify “friends” and another would identify contacts. In this embodiment, arrows 161 and 164 point to general contacts and arrows 162 and 163 point to friends. As seen in FIG. 7, the matching contacts are listed in the final column of the display. Since arrow 164 points to a general contact, the matching contact lists “Confidential” because of that member's previous designation. Since arrows 162 and 163 point to “friends,” the contact information for the matching contact is displayed. Though arrow 161 points to a contact, all contact information is given since the contact was provided by the user. As seen in the final column of FIG. 7, a user may select “Request Introduction,” which provides a manner for requesting the intervening contact to introduce the user to the matching contact (e.g., through an E-mail message such as the one shown in FIG. 14).

As discussed above, a trust level may be assigned to each contact in a subscriber's contact list. According to an embodiment of the present invention, the “inner circle” trust level is the highest level that can be assigned to a contact. The inner circle trust level allows subscribers to selectively invite other subscribers to not only search across their contact database but also browse in real time and view detailed contact information on the contacts in their individual databases.

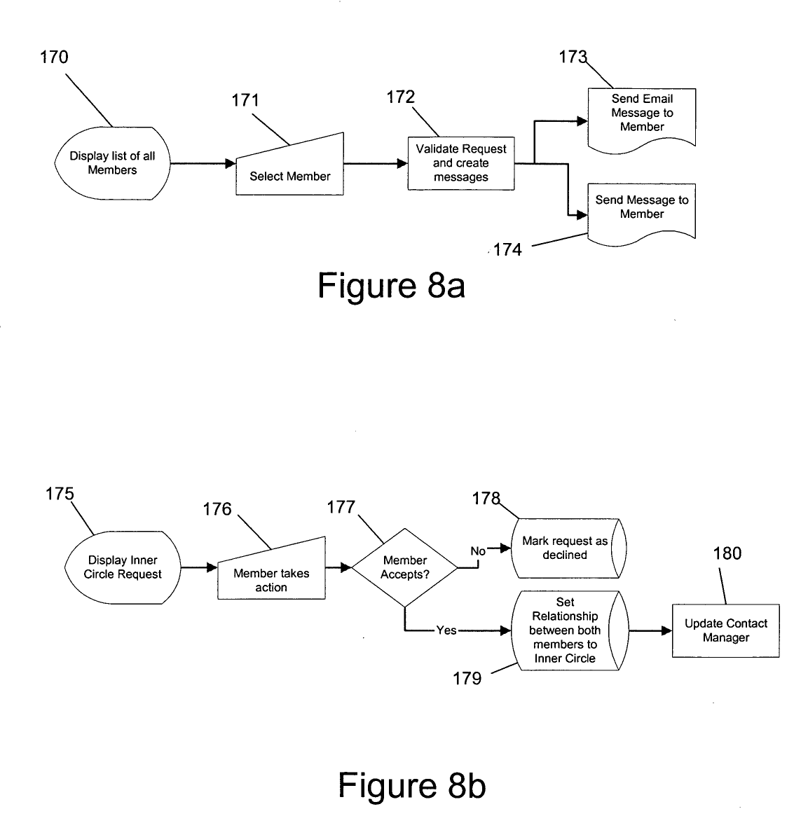

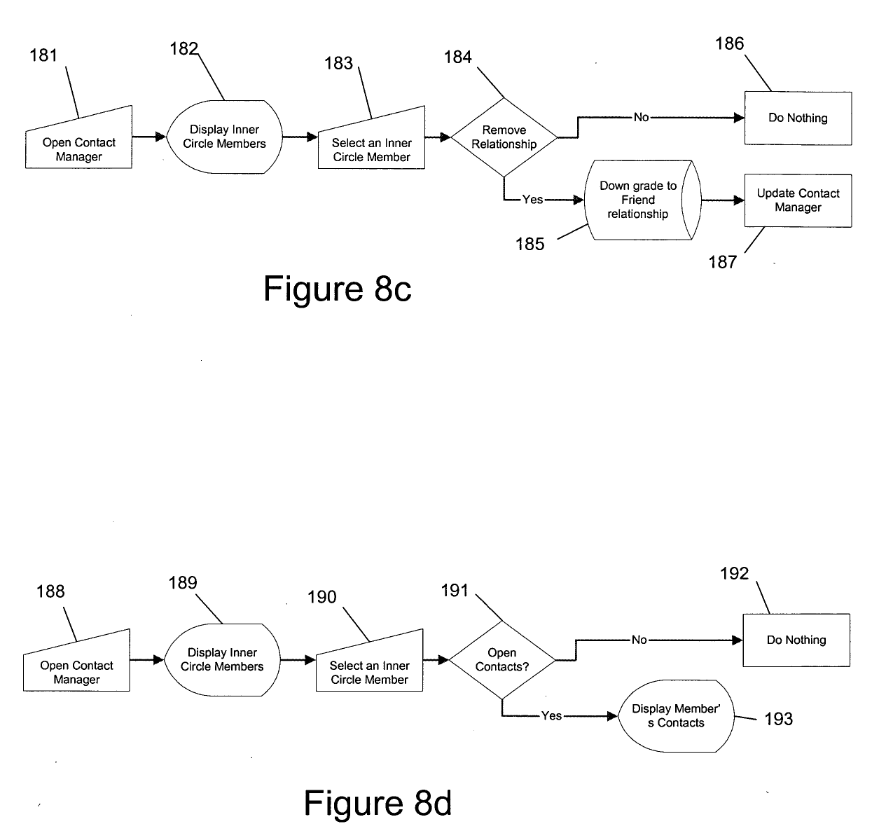

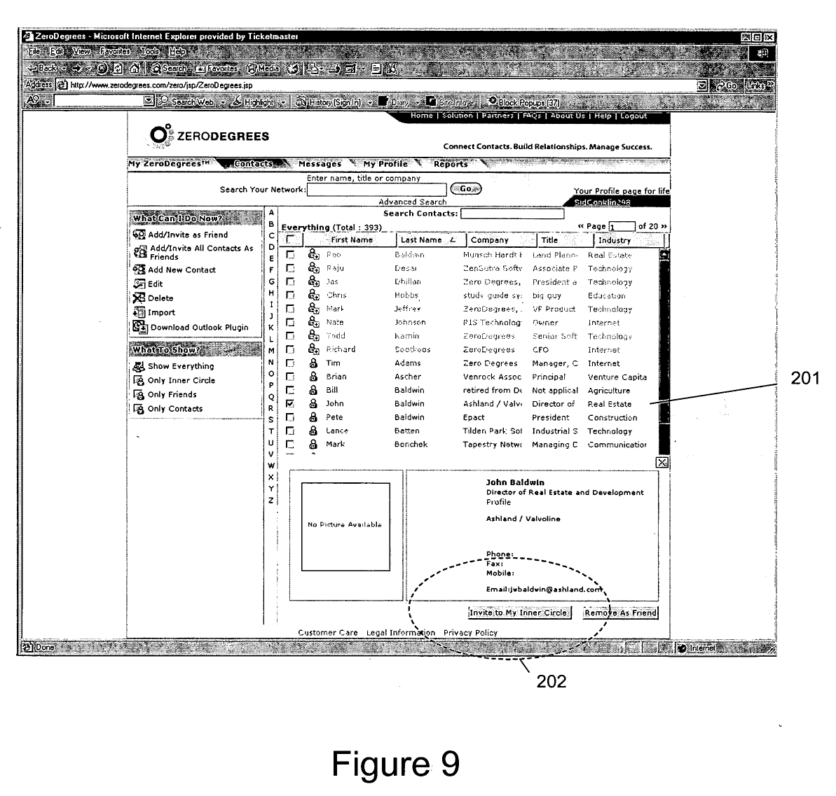

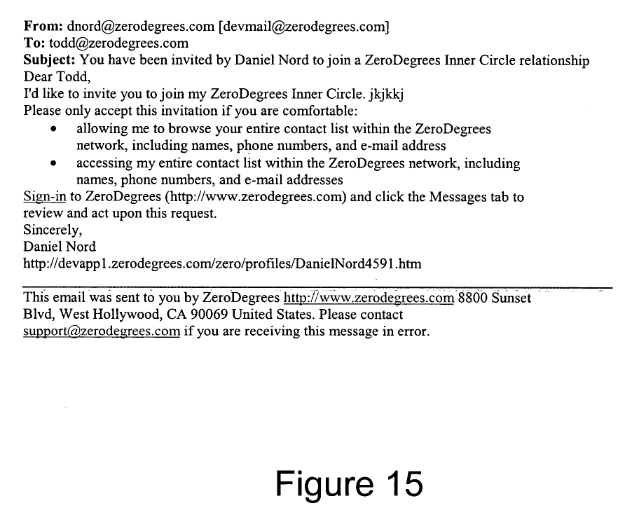

Referring to FIGS. 8a-d, flow diagrams are shown concerning aspects of the inner circle trust level according to an embodiment of the present invention. In FIG. 8a, an example of a method for inviting a member of the network to obtain an inner circle trust level for a subscriber is shown. In block 170, the list of all members is displayed to the subscriber. In block 171, the user/subscriber selects (e.g., with a cursor control device) one of the members to be given a higher trust level. In block 172, the request is validated and in block 173, a message is displayed to the user and in block 174, an E-mail message is sent to the selected member to invite him or her to participate in the higher trust level relationship with the user/subscriber (an example of such an E-mail message is shown in FIG. 15). As seen in FIG. 9, an example of a contact manager user interface is shown. The selected member 201 is highlighted and displayed in a lower window. The user can select “invite to My Inner Circle” 202 to initiate the sending of a invitation message to the selected member.

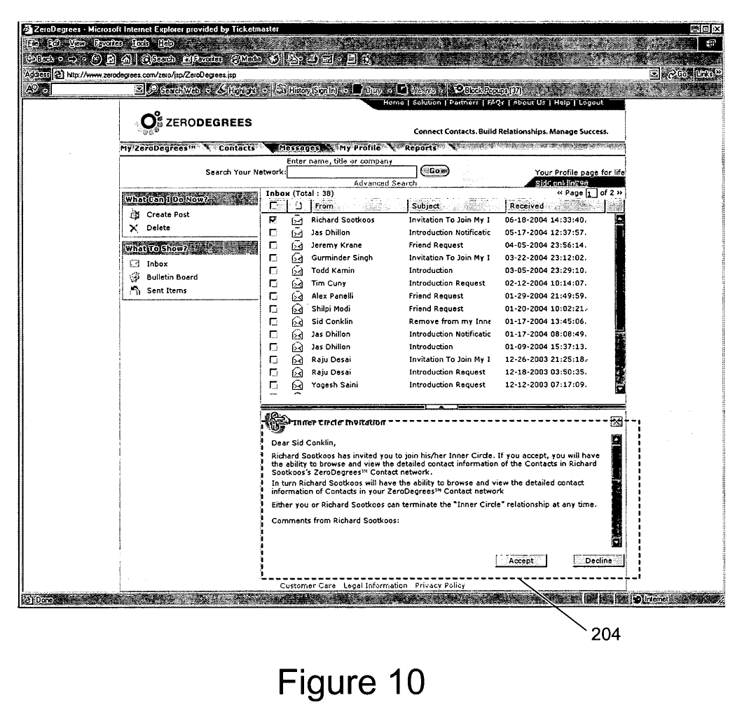

Referring to FIG. 8b, the invitation message is displayed to the selected member (block 175). In block 176, the selected member takes action (inputs acceptance or denial of the request). In decision block 177, if the selected member does not accept the request, then control passes to block 178 where the request is marked as “declined,” and a notification may be sent back to the user/subscriber. In block 179, when the selected member accepts the request, the relationship between the user and the selected member is set at the higher trust level. The contact manager for the user may then be updated (block 180). Referring to FIG. 10, an example of a contact manager user interface for the selected member is shown. The invitation is shown in the lower window 204, and the selected member is allowed to select “accept” or “decline” in this embodiment.

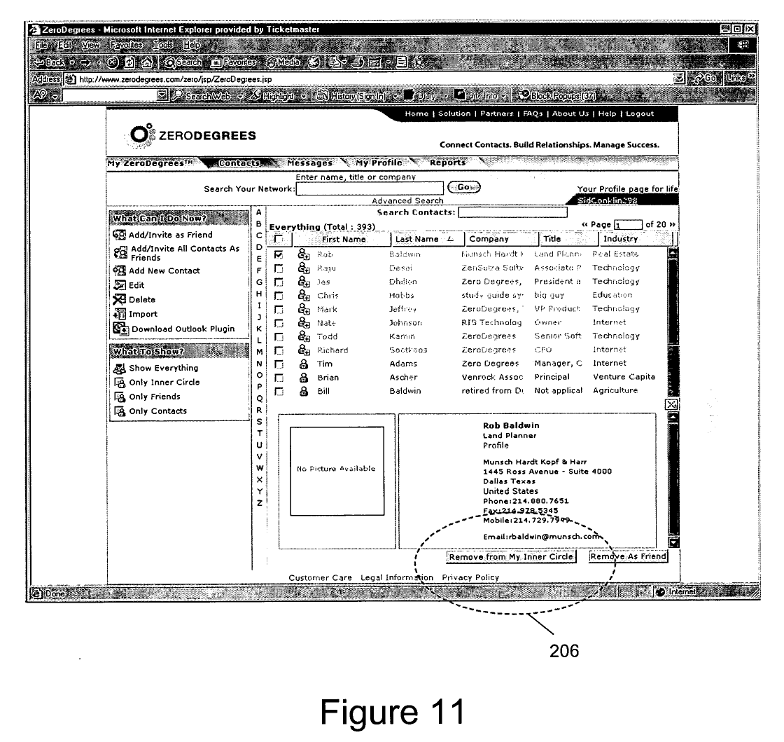

Referring to FIG. 8c, a user is also able to change the trust level for a contact. In block 181, the user opens the contact manager and displays it as in block 182 (see, e.g., FIG. 11). In block 183, the user is able to select an inner circle member from its contact list. If the user desires to change the trust level (or relationship) of the contact (see blocks 184 and 185), he/she may do so (e.g., by selecting the “remove from My Inner Circle” option 206 as shown in FIG. 11). In block 187, the contact manager (and the client's contact database) is updated. The user may also be given the opportunity to downgrade the trust level from friend to contact, or not change the trust level at all (block 186).

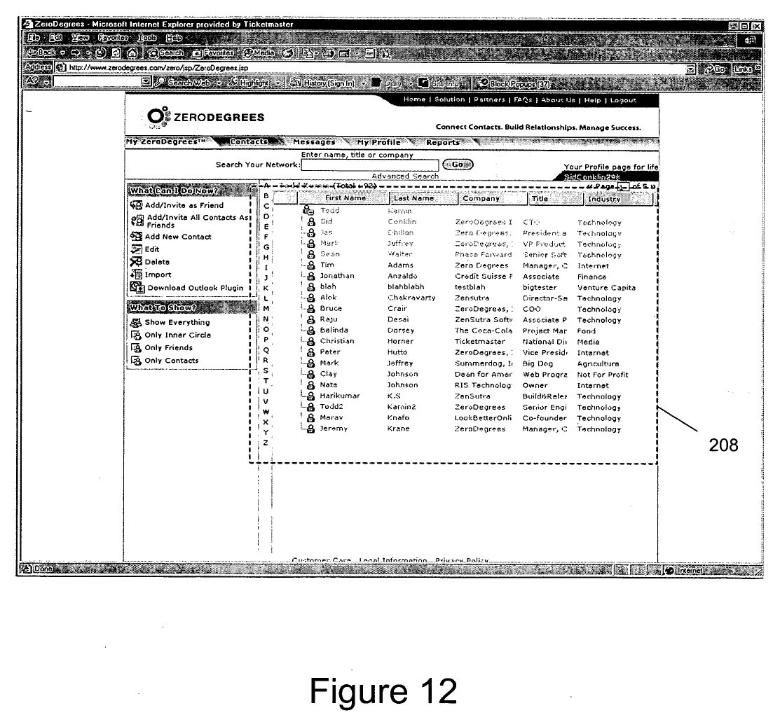

As described above, setting the trust level to a high level (e.g., “inner circle”) allows a user to see more information on the contacts for the member having such a high trust level. In the example of FIG. 8d, a user is able to open and view the contents of another member's contacts if that other member is an inner circle contact. In block 188, the user opens the contact manager and displays the inner circle contacts as in block 189 (see, e.g., FIG. 12). In block 190, the user is able to select an inner circle member (i.e., one where this high trust level has been previously created). The user may desire to open the contacts of the inner circuit member (block 191). In such a case, the contacts, including general contact, friends, and inner circle friends of the selected inner circle member can be displayed to the user (block 193). An example of such a list is shown as element 208 in FIG. 12.

Although several embodiments are specifically illustrated and described herein, it will be appreciated that modifications and variations of the present invention are covered by the above teachings and within the purview of the appended claims without departing from the spirit and intended scope of the invention.

1. A method of generating a contact list comprising:
Initiating a request to generate a list of contacts;
Accessing a storage of electronic mail messages corresponding to a user; and
Collecting a plurality of contacts from said stored electronic mail messages.

2. The method of claim 1 wherein said accessing step is performed on sent electronic mail messages corresponding to the user.

3. The method of claim 2 further comprising:
providing a weight value for each contact based on the electronic mail messages sent to said contact.

4. The method of claim 3 wherein said weight value is selected based on a number of electronic mail messages sent to said user.

5. The method of claim 3 wherein said weight value is selected based on a frequency of electronic mail messages sent to said user.

6. The method of claim 3 wherein said weight value is selected based on a currency of said electronic mail messages sent to said user.

7. The method of claim 3 further comprising:
Providing a list of said collected contacts at a computer display.

8. The method of claim 7 further comprising:
Selecting ones of said displayed contacts with a cursor control device.

9. A method of processing a contact list comprising:
Generating a list of user contacts pertaining to a user;
Providing a list of member contacts to a network, each member having associated with it relationships to a number of contacts; and
Determining whether each of said user contacts is a member contact.

10. The method of claim 9 further comprising:
If one of said contacts is not a member contact, transmitting a message to said user contact.

11. The method of claim 10 wherein said message is an electronic mail message to invite said user contact to become a member of said network.

12. The method of claim 9 further comprising:
If one said contact is a member contact, creating a relationship in said network between said user and contacts of said member contact.

13. The method of claim 9 further comprising:
Providing a web-based contact management system accessible by said user.

14. A method of synchronizing a contact list comprising:
Providing a list of user contacts pertaining to a user;
Providing a list of member contacts to a network, each member having associated with it relationships to a number of contacts; and
At a predetermined time, comparing said list of user contacts to said list of member contacts.

15. The method of claim 14 further comprising;
Updating said list of user contacts based on said comparing operation.

16. The method of claim 15 further comprising:
Transmitting a message to invite a user contact to become a member of said network.

17. The method of claim 16 wherein said updating step further includes updating data associated with one of said user contacts to indicate that said user contact has become a member of said network.

18. A method of searching a network of contacts wherein the network includes a number of relationships between contacts the method comprising:
Collecting data associated with each of the contacts in said network;
Creating a keyword index for said data;
Creating a relationship graph between each contact in the network;
Obtaining search criteria for a user;
Finding a match between said search criteria and said keyword index; and
Searching said relationship graph to determine a relationship between said user and a contact in the network corresponding to said match.

19. The method of claim 18 further comprising:
Displaying said relationship between said user and said contact in the network corresponding to said match.

20. The method of claim 19 wherein each relationship has a trust level.

21. The method of claim 20, wherein said displaying said relationship step includes displaying said trust level.

22. The method of claim 21, wherein said relationship between said user and said contact in the network corresponding to said match includes an intervening contact having a low trust level, and at least part of the data associated with the contact in the network corresponding to said match is prevented from being displayed.

23. The method of claim 21, wherein said relationship between said user and said contact in the network corresponding to said match includes an intervening contact having a high trust level, and all of the data associated with the contact in the network corresponding to said match is displayed.

24. The method of claim 19, wherein said relationship between said user and said contact in the network corresponding to said match includes an intervening contact, the method further comprising:
Sending a message to said intervening contact requesting an introduction between said user and said contact in the network corresponding to said match.

25. A method of managing a network of contacts wherein the network includes a number of relationships between contacts, the method comprising:
Selecting a member of the network of contacts by a user; and
Setting a trust level in a relationship between said user and said member.

26. The method of claim 25 further comprising:
Sending a message to said member by said user; and
Increasing said trust level in the relationship between said user and said member based on a response to said message by said member.

27. The method of claim 26 further comprising:
Providing access to a user to data associated with a contact list of said member based on said increased trust level.

28. A server system, comprising:
A server to store a network of contacts wherein the network includes a number of relationships between contacts, said server to receive a list of user contacts pertaining to a user and to determine whether each of said user contacts is represented in said network.

29. The server system of claim 28 wherein said server is to collect data associated with each of the contacts in the network, create a keyword index for said data, create a relationship graph between each contact in the network, receive search criteria for a user, find a match between said search criteria and said keyword index, and search said relationship graph to determine a relationship between said user and a contact in the network corresponding to said match.

30. The server system of claim 29 wherein said server is to select a member of the network of contacts by a user and set a trust level in a relationship between said user and said member.

31. A computer system, comprising:
A computer to access a storage of electronic mail messages corresponding to a user and collect a plurality of contacts from said stored electronic mail messages.
